(19) United States
(12) Patent Application Publication
(10) Pub. No.: US 2003/0179824 A1
(43) Pub. Date: Sep. 25, 2003

(54) Hierarchical video object segmentation based on MPEG standard

(76) Inventors: Ming-Cheng Kan, Chiai Hsien (TW); Chung J. Kuo, Chiai Hsien (TW); Guo-Zua Wu, Hsinchu Hsien (TW); Meng-Han Tsai, Hsinchu Hsien (TW)

Correspondence Address: BIRCH STEWART KOLASCH & BIRCH, PO BOX 747, FALLS CHURCH, VA, 22040-0747, US

(21) Appl. No.: 10/253,579

(22) Filed: Sep. 25, 2002

(30) Foreign Application Priority Data
Mar. 22, 2002 (TW) 91105524

(51) Int. Cl. H04N 7/12

(52) U.S. Cl. 375/240.1; 382/240

(57) ABSTRACT

The invention provides a video object segmentation process for parting video objects from a video or image based on Motion Picture Experts Group (MPEG) compression standard. The process uses MPEG-7 descriptors and watershed segmentation. A database stores MPEG-7 descriptors of video objects for comparison of image regions obtained from watershed segmentation and region combination. The region that is most similar to the descriptors of data in the database is the video object to be found.

### BACKGROUND OF THE INVENTION

1. Field of the Invention

The invention generally relates to a video object segmentation method, and particularly relates to an video object segmentation method based on Motion Picture Experts Group (MPEG) standard.

2. Related Art

In recent years, video-processing technologies are being continuously developed. More and more studies on video object segmentation are made. The earlier MPEG-1 or MPEG-2 algorithms are to delete the redundant data in the video signal. Till MPEG-4, a different compression algorithm, called content-based video coding, is used. The algorithm parts the video contents into several video object planes (VOP), then encodes, stores and transfers them. At the decoding section, the video object planes are reassembled, deleted or replaced according to the application requirements.

The current methods for video object segmentation mainly include automatic process and semi-automatic process. The automatic segmentation process is based on motion information of objects for parting a foreground object from the background. In this process, the video object planes can only be obtained by the moving objects. It is a good method for segmenting moving objects. But it is not applicable to static objects.

For static objects, a semi-automatic segmentation process has to be applied. The semi-automatic segmentation process requires a manual operation for finding out an initial video object through a computer-aided operation. The user has to define an approximate boundary of a video object through an interactive interface with the computer. Then the computer software finds out the detailed contour of the video object by an active contour model. Though the approach solves the problem of segmenting a static object, it always requires an initial manual operation, which is rather bothersome. Therefore, we need a simple and convenient method for parting video objects, whenever static or moving.

### SUMMARY OF THE INVENTION

The objective of the invention is to provide a method for segmenting static or moving video objects based on MPEG-7 standard. The method applies watershed segmentation and MPEG-7 descriptor comparison process. The concept of the method comes from jigsaw puzzle and object recognition of human brain. Our brains recognize objects by remembrance of their characteristics through learning processes. The invention utilizes similar processes of training a computer with video objects, establishing a database by extracting characteristics of the objects, and finally finishing object segmentation through the characteristics database. The extraction of characteristics of video object is based on the descriptors defined in MPEG-7 standard.

A method for video objects segmentation according to the invention includes the following steps. First, inputting a color image and transforming the image into a grayscale image. Detecting the minimum value of the gradient in grayscale image. Performing watershed segmentation based on the minimum value. Expanding the minimum value till a shed value. Using the shed value as a boundary to add a parting dam and parting the input image into several watershed regions. Combining the watershed regions based on an initial threshold. Numbering the combined watershed regions. Composing these watershed regions by using a comparator and a replacement threshold to find a most similar watershed region. Combing outwards and deleting inwards from a designated region, and processing hollow portions in the region when the area of the hollow portions is less than 2%. Continuing the process till the input image saturates. Then decrease the threshold. Comparing the prior video object with the later watershed region that is obtained by the lower threshold. Repeating the process loop till a threshold complies with a stop condition, then outputting the result.

### BRIEF DESCRIPTION OF THE DRAWINGS

The invention will become more fully understood from the detailed description given here in below. However, this description is for purposes of illustration only, and thus is not limitative of the invention, wherein:

FIG. 1 is a flowchart illustrating the process of the invention;

FIG. 2A is an explanatory illustration for texture descriptors in the invention;

FIG. 2B is an explanatory illustration for a bonding-box descriptor in the invention;

FIG. 2C is an explanatory illustration for a region descriptor in the invention;

FIG. 3A is an explanatory illustration for watershed segmentation according to the invention;

FIG. 3B is an example result of watershed segmentation through method of FIG. 3A;

FIG. 3C is an example result of watershed region merge of FIG. 3B with a threshold;

FIG. 3D is another example result of watershed region merge of FIG. 3B with another threshold;

FIGS. 4A, 4C and 4E are example results of watershed region merge with different thresholds;

FIGS. 4B, 4D and 4F are the most similar video objects corresponding to FIGS. 4A, 4C and 4E after comparing with a database;

FIGS. 5A to 5C are explanatory illustrations for correlative watershed regions processing to the invention;

FIG. 6A is an example of a designated region and its adjacent regions;

FIG. 6B is an example result of “including” regions according to the invention;

FIG. 6C is an example result of “excluding” regions according to the invention;

FIG. 6D is an example result of processing hollow portions located among regions according to the invention;

FIGS. 7A and 7B are examples of initial images to be processed by the invention;

FIGS. 7C and 7D are extracted objects through MPEG-7 descriptors of the invention; and

FIGS. 7E and 7F are the most similar video objects found out from the initial video image according to the invention.

### DETAILED DESCRIPTION OF THE INVENTION

The invention provides a method for static or moving video object segmentation based on MPEG-7 standard. The method applies layered watershed segmentation and MPEG-7 descriptor comparison process.

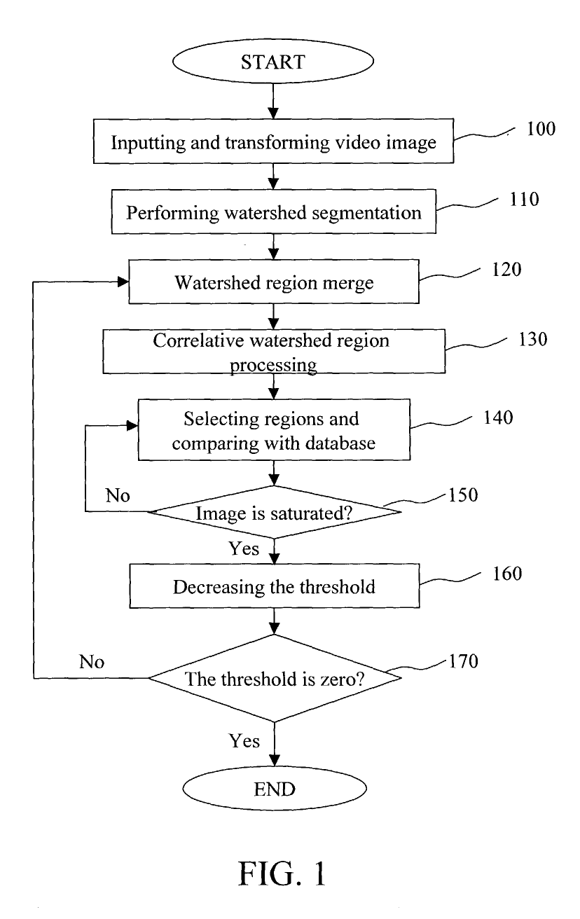

1. As shown in FIG. 1, the process for video object segmentation based on MPEG-7 standard includes the following steps. First, establishing a video object database by using MPEG-7 descriptors. Then, importing video image and transforming it into grayscale (step 100). Performing watershed segmentation (step 110) and merging segmental watershed regions with an initial threshold (step 120). The initial threshold is based on color difference between adjacent regions. Further, correlative watershed region processing (step 130), combining selected regions, and comparing with the database (step 140). The pixels in the video object of combined region are still with original red-green-blue (RGB) values. The computer process repeats the region combination and database comparison till the comparison result is not better than the current most similar video object when being compared to the database, i.e., the region selected process is saturated (step 150). Then, decreasing the threshold (step 160). Further performing watershed region merge, correlative watershed region processing with the currently most similar video object, and further combining selected regions and comparing with database. The process proceeds till the threshold comes to zero or a stopping condition (step 170).

The major steps in the invention includes establishing a database, selecting an initial threshold, inputting and transforming the image, performing watershed segmentation, correlative watershed region processing, and selecting regions and comparing with database. The detailed processes will be described below.

2. Establishing Database

In order to make computer know video objects, some video object descriptors defined with MPEG-7 have to be generated and stored in a database. The descriptor database complies with MPEG-7 standard for visual part. The training resembles human recognition to objects. Human recognizes objects by first memorizing characteristics of the objects and later recognizing the objects upon seeing them. The MPEG-7 descriptor includes data of color, texture, shape, motion (including camera motion and object motion) and so on. The color, texture and shape descriptors will further be described below.

The color descriptor includes color space, dominating color, color layout, color histogram, scalable color and color quantization. The color space may includes RGB, component video (YCrCb), hue saturation value (HSV) or M[3][3], which is a transform matrix based on RGB values. The dominating color is the major color of the object. The major color values and their area percentage are described and used as parameters for searching similar objects. The color histogram represents the statistics of each color, which is a good reference for searching similar image. The color quantization for quantizing the color scale is made by a linear mode, a nonlinear mode, or a lookup table.

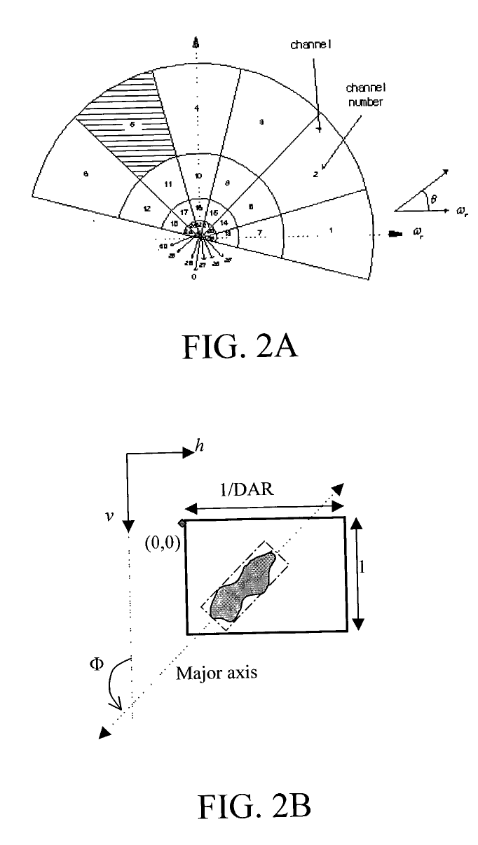

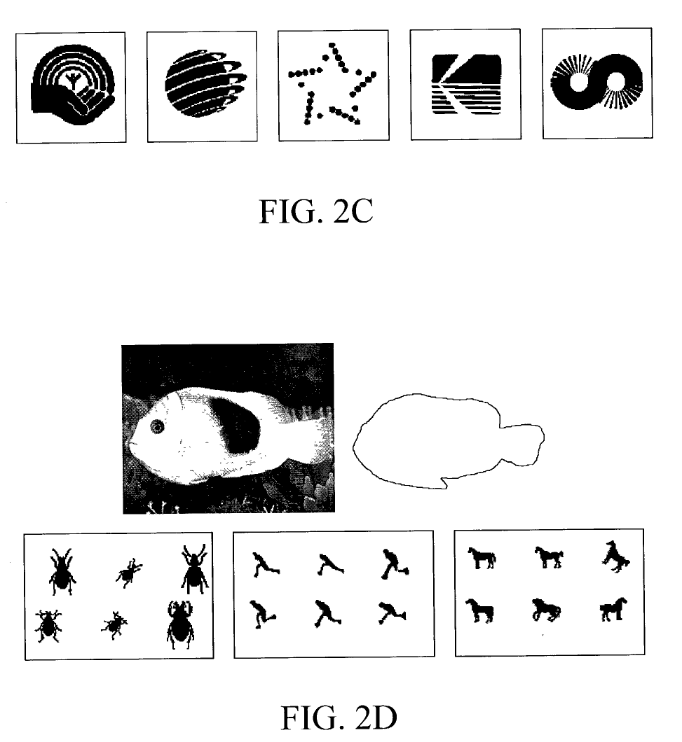

The texture descriptor includes homogeneous texture and edge histogram. The texture descriptor is to describe the direction, roughness and orderliness of the image. To describe texture, an image is parted circularly into six regions in a half circle area as shown in FIG. 2A. And, further divided in radius direction into 30 sections (five in each region). A matching function is applied to these sections in radius and in circular directions so as to obtain the results.

The shape descriptor is generally described with object bounding box, region-based shape descriptor, contour-based shape descriptor or shape 3D descriptor. An object bounding box, as shown in FIG. 2B, is a minimum rectangular box for covering an object. The box can be defined with a distance-to-area ratio (DAR), relative position (h, v) and the angle of the major axis of the object to the coordinate axis. A region-based shape descriptor describes objects with their occupation area, such as area of trademarks, as shown in FIG. 2C. A contour-based shape descriptor describes objects with their contours. The contour is defined with curvature scale space, as shown in FIG. 2D, which can be scaled, rotated, distorted or hindered.

3. Selecting Initial Threshold

Since it is possible to combine fault object regions during watershed region merge, a suitable threshold has to be decided. The invention starts with an initial threshold determined by the system. The initial threshold is a value when an input region is being compared with the database and there exists most similar descriptors. The threshold is a value of color difference between adjacent regions.

The decision process starts from “0” threshold for region combination. The combined regions are compared with the database. After “0” threshold finishes, an increased threshold with an increment is used for watershed region merge. The number of total regions is decreased, and the region area is enlarged. Then the combined regions are compared with the database. The threshold increment process repeats till only one region exists.

4. Inputting and Transforming Image

The input image is a RGB color image. In order to simplify watershed segmentation, the input image is transformed into a grayscale image before watershed segmentation. The transformation is made through Y-axis definition of YUV color system. The YUV color system is a common video signal standard adopted by NTSC, PAL and SECAM systems, in which Y is a luminance signal, and U and V are chrominance signals. The equations for YUV to RGB are as follows (Equations 1).

Y=0.299R+0.587G+0.112B

U=−0.147R−0.289G+0.434B

V=0.615R−0.515G−0.1B (1)

5. Performing Watershed Segmentation

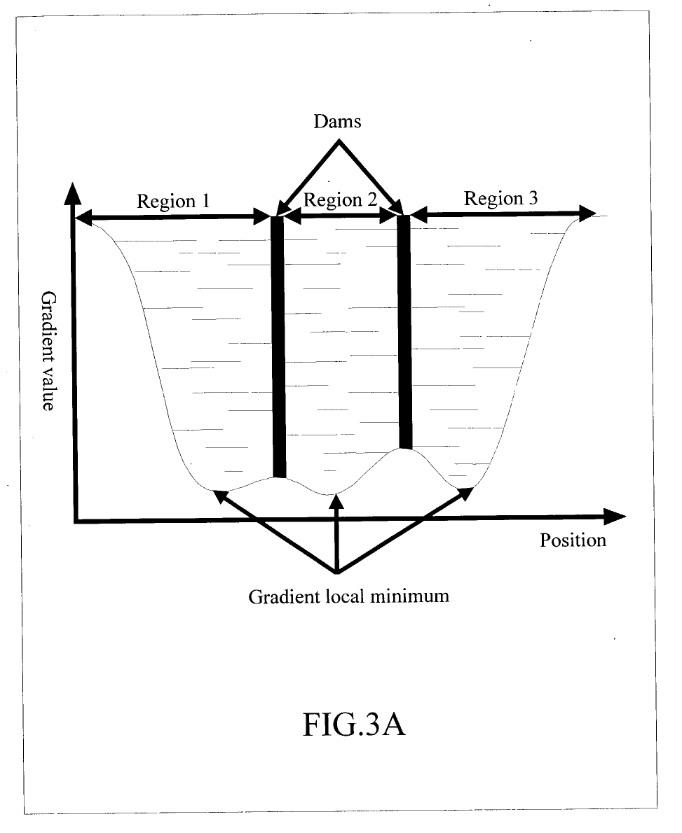

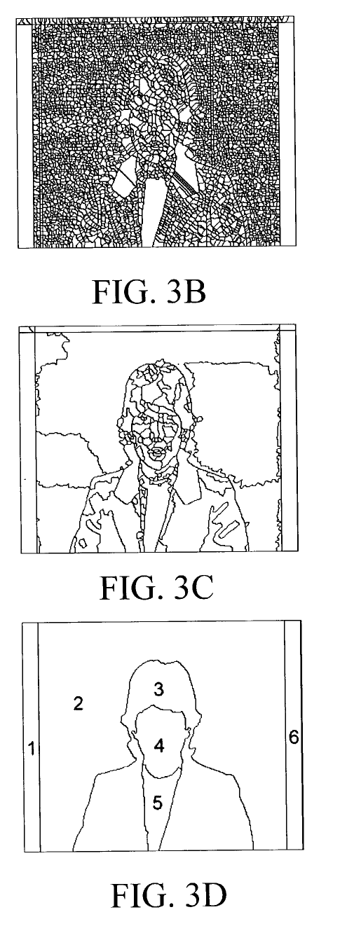

Watershed segmentation is an algorithm to classify image pixels into similar-color regions. The invention applies the process with grayscale image. As shown in FIG. 3A, a minimum grayscale value is first detected. Expanding from the minimum value, some watersheds are obtained. At the watershed, a dam is settled to stop regional overflow from adjacent regions. The watershed therefore parts the image into different regions. But, the watershed method is very sensitive to grayscale image, therefore, a lot of regions are generated by watershed segmentation, as shown in FIG. 3B, which require a region merge process to decrease regions as shown in FIGS. 3C and 3D. The invention uses color difference value of adjacent regions as a threshold and merges adjacent regions when the color difference is less than the threshold.

The color difference is defined by the following equation (Equation 2):

$$Color difference = \sqrt{\frac{{( R1 . R - R2 . R )}^{2} + 2 {( R1 . G - R2 . G )}^{2} + {( R1 . B - R2 . B )}^{2}}{4}} \qquad ( 2 )$$

Wherein, R1, R2 are adjacent regions;

R1.R, R2. R are average pixel values of red color in the regions R1, R2 respectively;

R1.G, R2.G are average pixel values of green color in the regions R1, R2 respectively; and

R1.B, R2.B are average pixel values of blue color in the regions R1, R2 respectively.

In order to save process time, the merge is started from a predetermined threshold, and decreased with a decrement after finishing with a threshold and obtaining an unsatisfied result. The process repeats till the threshold is “0” or meets a minimum difference value defined by the user.

6. Correlative Watershed Region Process

In order to solve the problem of over-segmentation caused by watershed segmentation process, region merge is generally required. However, different threshold will cause different merge result. It is sure that a higher threshold makes fewer merged regions, simpler objects but less precision. The invention utilizes the characteristics and provides a layered segmentation process for saving process time.

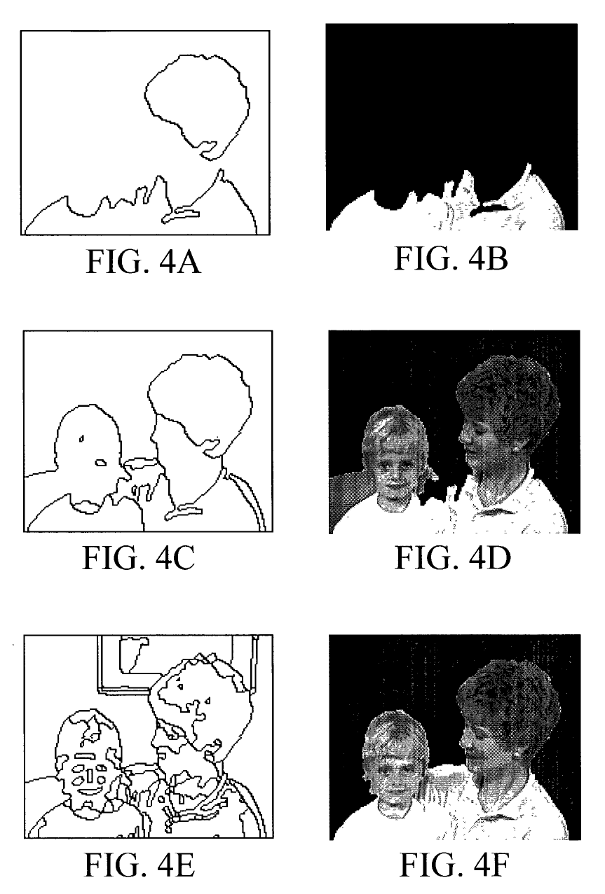

FIGS. 4A, 4C and 4E are results of region merge by thresholds of 45, 30 and 15 respectively. And, FIGS. 4B, 4D and 4E are the most similar video objects found in the database according to the results of region merge.

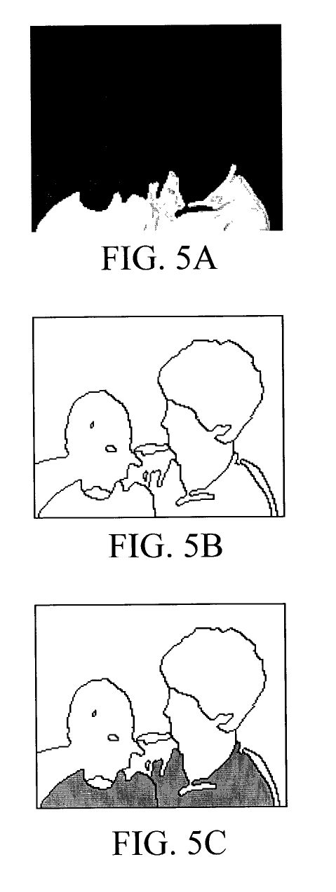

The process of watershed region processing according to the invention will be described with examples of results of FIGS. 4B and 4C and procedures shown in FIGS. 5A to 5C. It is apparent, from FIGS. 4A, 4C and 4E, that a larger threshold gets a larger region. According to the aforesaid threshold selection, region merge and database comparison, the image of FIG. 4B may have been obtained as a most similar video object when being compared to the database.

Then, the invention further processes the results of FIGS. 4B and 4C to refine the watershed regions. The processes are illustrated in FIGS. 5A to 5C. As shown in FIG. 5B, after decreasing the threshold, the new threshold regions are obtained. By comparing them to the prior objects of FIG. 5A, the corresponding gray regions and other new regions, as shown in FIG. 5C will be found. In other words, the corresponding gray regions match the video object of FIG. 5A and the rest regions of FIG. 5B will be labeled for further combination and comparison.

Briefly speaking, the watershed process starts from larger regions. It first performs watershed segmentation, combines the regions with an initial (larger) threshold, and compares the result with the database. Then, it repeats the combination and comparison by using decreased thresholds so as to get detailed regions and finally obtains the best result.

7. Selecting Regions and Comparing with Database

After watershed segmentation, the regions are labeled with numbers as shown in FIG. 3D. Then, the regions are chosen and processed in the following manners.

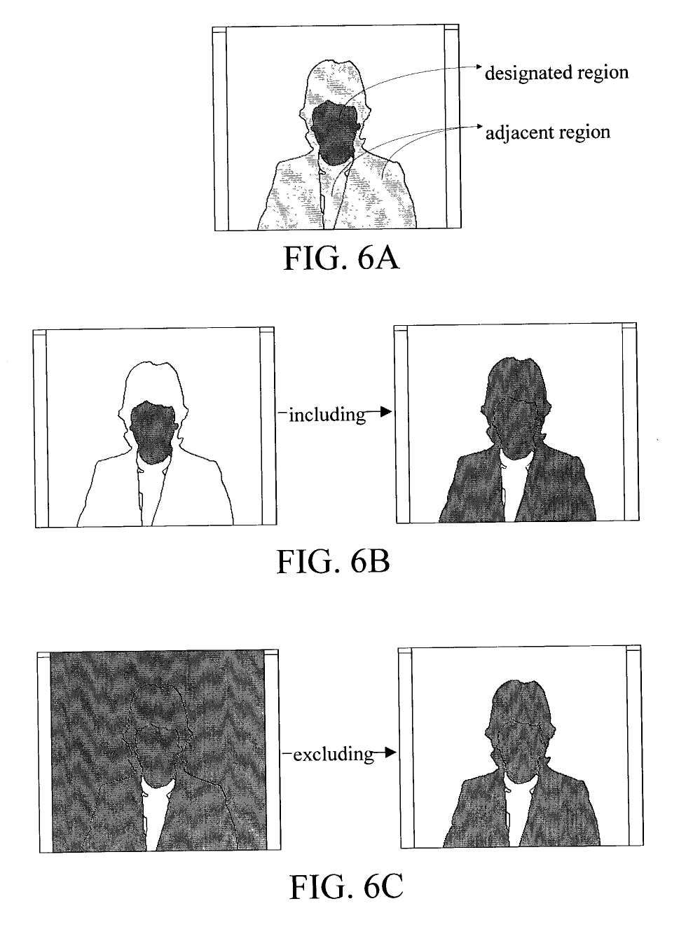

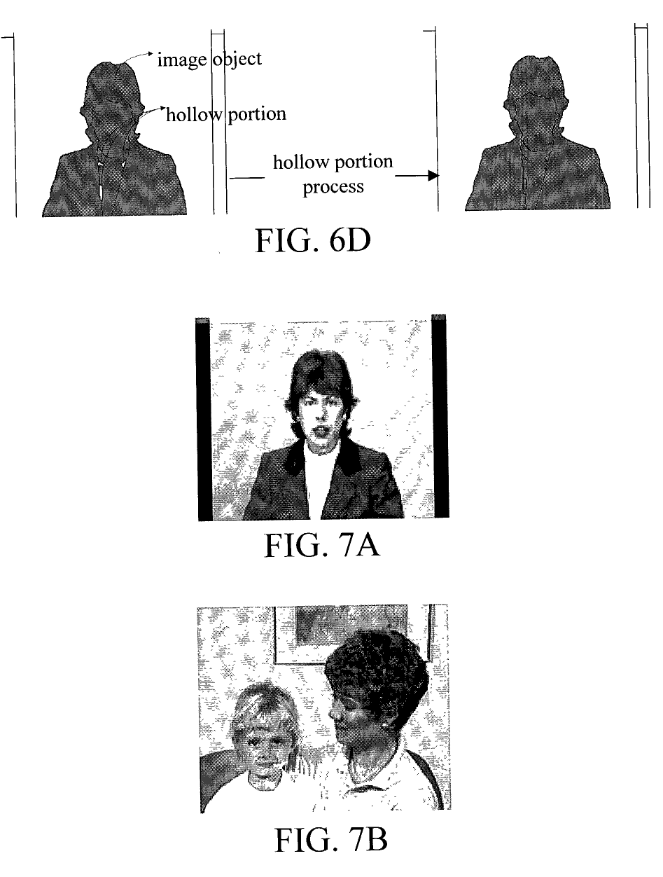

As described above, a combined region based on a suitable threshold can be found similar to data of the database. The region is called a “designated region”. Then the designated region is further processed to include or exclude some adjacent regions and formed a new “designated region”. To add at least an adjacent region to the designated region is called “inclusion”. While, to subtract at least a region from the designated region is call “exclusion”. The inclusion, exclusion and another process of filling up hollow portions within the regions are illustrated with FIGS. 6A to 6D. FIG. 6A is an example of a designated region and its adjacent regions. FIG. 6B is an example result of “including” regions. FIG. 6C is an example result of “excluding” regions. FIG. 6D is an example result of processing hollow portions located among regions. After including adjacent regions, some small regions maybe left among the adjacent portions and formed hollow portions, which have to be checked and filled up (i.e., included) before a further inclusion.

The hollow portion process is to verify if there is any small region located inside the designated region. When the area of the small region is less than 2% of the designated region, the small region (hollow portion) will then be included to the designated region, and the designated region is updated for further process.

The database comparison includes tasks of “comparator” and “replacement”. The comparator is to compare the video data between a designated region and the database. The comparison is based on a similarity matching function for checking the difference of MPEG-7 descriptors. The pixels of the designated region are compared with their RGB values.

The MPEG-7 descriptors for the similarity matching function include a color histogram descriptor. For comparing the color histogram, the characteristics of an original data A and a compared data B have to be first extracted according MPEG-7 standards. The comparator utilizes the similarity matching criteria defined by the descriptor. The similarity of color histogram of the two data A and B is generally calculated by using suitable weighting values. For example, a color histogram with HSV coordinates is weighted by the following equation (Equation 3).

$$\begin{matrix}{w}_{ij} = 1 - \sqrt{\frac{{( v ( i ) - v ( j ) )}^{2} + {( s ( i ) \cdot cos h ( i ) - s ( j ) \cdot cos h ( j ) )}^{2} + {( s ( i ) \cdot sin h ( i ) - s ( j ) \cdot sin h ( j ) )}^{2}}{2}} \\ W = [ {w}_{i , j} ] ; 0 \leq i < number\_of \_cells ; 0 \leq j < number\_of \_cells\end{matrix} \qquad ( 3 )$$

Supposing hist[A] is a set of color histogram of data A, and hist[B] is a set of color histogram of data B, then according to the aforesaid weighting, the color histogram similarity of the data A and B are calculated from the following equation (Equation 4). In which, a smaller dist(A, B) means a higher similarity.

dist(A,B)=[hist(A)−hist(B)]^{T}W[hist(A)−hist(B)] (4)

The comparator compares all the descriptors of MPEG-7 between the designated region and the video object data in the database. Each descriptor has a similarity matching criteria, which is used for calculating the difference between two data. The result of comparison is then used for selecting the most similar video object.

In the region selection and database comparison, the comparison result is registered only when the result reaches a “replacement threshold”. That means, only the designated region corresponding to a more similar video object is taken for further process. The replacement threshold is defined as follows (Formula 5).

$$\{ \begin{matrix}CN > ( ( Total\_Number \_Descriptor - SN ) \times ( 2 / 3 ) ) \\ CN > 0\end{matrix} \qquad ( 5 )$$

in which CN is the total number of descriptors of the data having less similarity; Total_Number_Descriptor is the total number of descriptors for comparison; and SN is the total number of descriptors of the data having the largest similarity.

Because the characteristics of each descriptor are different, it is not necessary that all the descriptors committing data replacement criteria. Therefore, the invention predetermines the aforesaid replacement threshold for decision of data replacement.

As described above, the region selection and database comparison starts from finding a suitable “designated region”. Then, performing a region inclusion and comparing the new region with the database. If the corresponding video object of the new region reaches the replacement threshold, then replacing the new region as the designated region for further inclusion and comparison. Repeating the process till the new region does not reach the replacement threshold. Then setting the inclusion as “saturated” and stopping inclusion.

Now processing the hollow portions, filling up any hollow portion in the designated region. If detected a hollow portion is less than 2% of the designated region, then setting the inclusion as “unsaturated”. And then performing a region exclusion and comparing the new region with the database. If the corresponding video object of the new region reaches the replacement threshold, then replacing the new region as the designated region for further exclusion and comparison. Repeating the process till the new region does not reach the replacement threshold. Then setting the exclusion as “saturated” and stopping exclusion.

Further, repeating the processes of inclusion, hollow-portion filling and exclusion based on new designated regions found under decreased thresholds of watershed region merge, and finding out the final designate region that is the most similar video object.

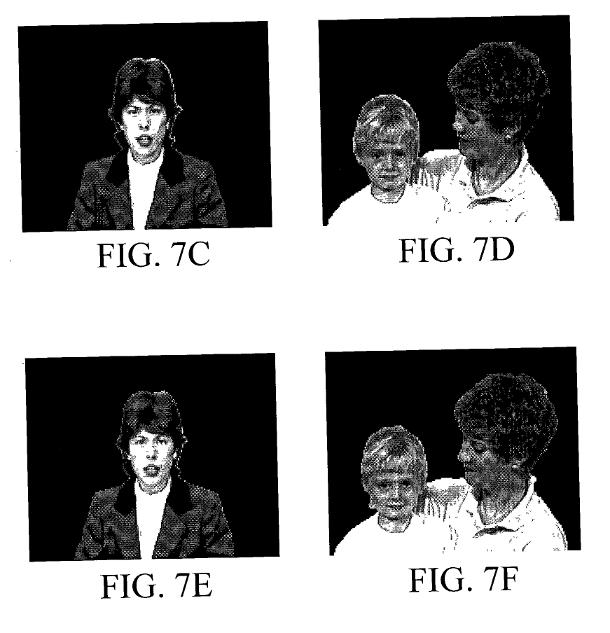

Two examples of video object parting are shown in the drawings. FIGS. 7A and 7B are original images of 176*144 pixels. FIGS. 7C and 7D are video objects stored in the database through MPEG-7 descriptor extraction respectively from aforesaid original images. FIGS. 7E and 7F are results of video objects segmentation processed by the invention respectively from aforesaid original images. It is noticeable that the process of the invention can obtain a satisfactory result.

Since most MPEG-7 descriptors are not influenced by rotation of image, the application of content-base retrieval as the invention using can work well. As long as there are video object data and relative MPEG-7 descriptors stored in the database, the invention can utilize watershed segmentation and MPEG-7 descriptor comparison to find out video object from a static or moving image.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for hierarchical video object segmentation based on Motion Picture Experts Group standard, comprising steps of:
inputting a color video image and transforming the image into a grayscale image;
detecting a minimum value of the grayscale spectrum, performing watershed segmentation based on said minimum value, expanding said minimum value till a shed value, using said shed value as a boundary to add a parting dam and parting said input image into several watershed regions;
merging said watershed regions based on an initial threshold;
numbering said merged watershed regions;
composing said watershed regions by using a comparator and a replacement threshold to find a most similar watershed region, combing outwards and deleting inwards from a designated region, and processing hollow portions in the region when the area of the hollow portions is less than a predetermined percentage, continuing said process till said input image saturates;
decreasing said threshold, correlative watershed region processing and repeating region combination and comparison till a threshold complies with a stop condition, and
outputting said video result.

2. A method for hierarchical video object segmentation based on MPEG standard according to claim 1 further comprises a step of establishing a database and a step of determining said initial threshold.

3. A method for hierarchical video object segmentation based on MPEG standard according to claim 2 wherein said database is established by extracting characteristics of the video object with MPEG-7 descriptors.

4. A method for hierarchical video object segmentation based on MPEG standard according to claim 3 wherein said MPEG-7 descriptors comprises color, texture and shape descriptors.

5. A method for hierarchical video object segmentation based on MPEG standard according to claim 4 wherein said color descriptor is chosen from a combination of color space, dominant color, color histogram, scalable color, color quantization and color layout.

6. A method for hierarchical video object segmentation based on MPEG standard according to claim 4 wherein said texture descriptor is chosen from a combination of homogeneous texture and edge histogram.

7. A method for hierarchical video object segmentation based on MPEG standard according to claim 4 wherein said shape descriptor is chosen from a combination of object bounding box, region-based descriptor, contour-based shape descriptor and shape 3D descriptor.

8. A method for hierarchical video object segmentation based on MPEG standard according to claim 2 wherein said initial threshold is determined by a system initial threshold.

9. A method for hierarchical video object segmentation based on MPEG standard according to claim 1 wherein said step of watershed region merge is made when color difference between threshold regions is less than said initial threshold.

10. A method for hierarchical video object segmentation based on MPEG standard according to claim 1 wherein said step of composing watershed regions by using a comparator is to compare video object descriptors with database with a similarity matching criteria, and replace the video image as a most similar video object when a comparison result reaches a replacement threshold.

11. A method for hierarchical video object segmentation based on MPEG standard according to claim 10 wherein said video object is compared by pixels in regions, said pixels are described with original red-green-blue values.

12. A method for hierarchical video object segmentation image based on MPEG standard according to claim 10 wherein said replacement threshold is determined by ⅔ of a subtraction of total number of descriptors of said most similar video object from total number of descriptors for comparison.

13. A method for hierarchical video object segmentation based on MPEG standard according to claim 1 wherein said input image saturates when there is not a more similar result.

14. A method for hierarchical video object segmentation based on MPEG standard according to claim 1 wherein said step of correlative watershed region processing is to match said most similar video region with said number of said new combined region obtained by decreased threshold.

15. A method for hierarchical video object segmentation based on MPEG standard according to claim 1 wherein said stop condition of threshold decreasing is chosen from a combination of value of zero and value determined by user.

16. A method for hierarchical video object segmentation based on MPEG standard according to claim 1 wherein said step of outputting video result is to output said most similar video object.
